(19) United States
(12) Patent Application Publication
(10) Pub. No.: US 2010/0095261 A1
(43) Pub. Date: Apr. 15, 2010

(54) Timing analysis apparatus and timing analysis method

(75) Inventor: Noriyuki Ito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/654,038

(22) Filed: Dec. 8, 2009

Related U.S. Application Data
(63) Continuation of application No. PCT/JP2007/062391, filed on Jun. 20, 2007.

(51) Int. Cl. G06F 17/50

(52) U.S. Cl. 716/6

(57) ABSTRACT

A apparatus includes: an acquisition section that acquires information on a plurality of paths which let signals propagate in the integrated circuit in descending order of propagation time; a path capability distribution calculation section that calculates, based on the acquired information on the plurality of paths, path capability distribution; an integrated circuit capability distribution calculation section that performs a statistical operation based on the path capability distribution and on first integrated circuit capability distribution, and determines the result of the statistical operation as second integrated circuit capability distribution; and an evaluation section that calculates a parameter representing a difference between the first integrated circuit capability distribution and the second integrated circuit capability distribution, and repeats the process of the acquisition section, the process of the path capability distribution calculation section, and the process of the integrated circuit capability distribution calculation section until the parameter satisfies a predetermined condition.

### CROSS-REFERENCE TO RELATED APPLICATIONS

This application is a continuation application, filed under 35 U.S.C. §111(a), of PCT Application No. PCT/JP2007/062391, filed on Jun. 20, 2007, the disclosure of which is herein incorporated in its entirety by reference.

### FIELD

The embodiment discussed herein is related to a timing analysis apparatus and a timing analysis method which perform a timing analysis of an integrated circuit.

### BACKGROUND

A plurality of LSI (Large Scale Integrated circuit) chips are formed on a wafer cut out of a lot, and every LSI chip is cut out of the wafer. In this manner, the LSI chips are produced. However, even if the LSI chips are the same in design, frequency characteristics are different depending on where the LSI chips are formed on the wafer. Accordingly, even if the LSI chips are formed on the same wafer, frequency characteristic varies from one chip to another. Similarly, since many wafers are cut out of one lot, frequency characteristic varies from one LSI chip to another on each wafer.

Especially in the case of a state-of-the-art high-speed LSI chip, the LSI chip cannot be designed to leave a margin in a spec. Therefore, the LSI chip is so designed as to have a value close to the operating frequency in the spec.

If the operating frequency of the LSI chip is low, the yield rate of the LSI chips (the timing yield rate of the LSI chips satisfying a predetermined frequency characteristic) is taken into consideration, and the LSI chip is so designed to have a larger operating frequency than the operating frequency in the spec and is produced. Accordingly, the timing yield rate of the LSI chips satisfying the operating frequency becomes larger, and the number of LSI chips that users of LSI chips have to throw away because the LSI chips do not satisfy the operating frequency after buying the LSI chips decreases, thereby reducing wasteful costs.

However, if the LSI chip runs at very high speed, the operating frequency cannot be designed to be sufficiently larger than the operating frequency in the spec. Accordingly, the yield of the LSI chips satisfying the operating frequency gets worse. Therefore, the timing yield rate of the LSI chips satisfying the operating frequency becomes small, leading to a decrease in the number of LSI chips that users of LSI chips can use to produce electronic devices that use the LSI chips.

In such a case, the users of LSI chips predict the yield of LSI chips in advance. Based on the predicted yield rate, the users buy more LSI chips than necessary, and select those that can be used for a targeted device. However, if the prediction of the LSI yield rate is wrong, the number of LSI chips could be insufficient or redundant, which is not favorable in terms of cost.

The following conventional technologies relevant to the above are well known: an estimation method of the yield of integrated circuits, a high-precision simulation method for production of semiconductor devices, a method of increasing the yields in a semiconductor integrated circuit production process, and a statistical max operation.

### [Patent Document 1] Japanese Laid-open Patent Publication No. 10-294247

### [Patent Document 2] Japanese Laid-open Patent Publication No. 11-330449

### [Patent Document 3] Japanese Laid-open Patent Publication No. 2001-159809

[Non-Patent Document 1] Anirudh Devgan, and Chandramouli Kashyap, “Block-based Static Timing Analysis with Uncertainty,” Proceeding of the 2003 IEE/ACM international conference on Computer-aided Design, 2003.

As described above, the users of LSI chips need to predict the yield (timing yield rate) of the LSI chips in advance and buy, in accordance with the prediction, more LSI chips than necessary. However, people have conventionally relied on experience and intuition to predict the yield, or calculated the operating frequencies of all paths of the LSI chips to predict the yield.

### SUMMARY

According to an aspect of the invention, a timing analysis apparatus performs a timing analysis of an integrated circuit, the apparatus comprising: an acquisition section that acquires information on a plurality of paths which let signals propagate in the integrated circuit in descending order of propagation time; a path capability distribution calculation section that calculates, based on the acquired information on the plurality of paths, path capability distribution which is a probability density function of capability of the plurality of paths; an integrated circuit capability distribution calculation section that performs a statistical operation based on the path capability distribution and on first integrated circuit capability distribution which is a probability density function of capability of the chip, and determines the result of the statistical operation as second integrated circuit capability distribution which is a probability density function of capability of the chip, the first integrated circuit capability distribution being the path capability distribution calculated first or the second integrated circuit capability distribution determined last; and an evaluation section that calculates a parameter representing a difference between the first integrated circuit capability distribution and the second integrated circuit capability distribution, and repeats the process of the acquisition section, the process of the path capability distribution calculation section, and the process of the integrated circuit capability distribution calculation section until the parameter satisfies a predetermined condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a yield prediction process according to a prerequisite technology;

FIG. 2 is a graph illustrating an example of the distribution of timing yield rates obtained by the prerequisite technology;

FIG. 3 is a flowchart illustrating an example of a process of calculating variations in chips according to the prerequisite technology;

FIG. 4 is a block diagram illustrating an example of the configuration of a timing analysis apparatus according to an embodiment of the present invention;

FIG. 5 is a flowchart illustrating an example of the operation of the timing analysis apparatus according to the embodiment of the present invention; and

FIG. 6 is a graph illustrating an example of the definition of sensitivity according to the embodiment of the present invention.

### DESCRIPTION OF EMBODIMENTS

Firstly, the following describes a prerequisite technology.

An LSI timing yield rate prediction method of the prerequisite technology carries out examinations in accordance with the following steps.

Step 1: A statistical timing analysis is conducted on the design data of a chip (LSI) to obtain the prediction of frequency distribution of the timing yield rate of the chip with variations in the chip being taken into consideration. The variations in the chip are variations of an operating frequency of an individual LSI chip and are attributable to production tolerances of the operation of components formed in the chip, such as a plurality of flip-flops (FF).

Step 2: The spec value of the oscillating frequency of a ring oscillator embedded in the LSI chip and information on the distribution of ring oscillator oscillating frequencies of the chip whose frequency yield is to be predicted are collected from each of a plurality of chips, and are compared. If there is a difference between the spec value of the oscillating frequency of the ring oscillator and the actually measured distribution of ring oscillator oscillating frequencies, it is considered that the center of the distribution of ring oscillator oscillating frequencies of the chip whose frequency yield is to be predicted has deviated from the spec value due to variations among the chips. The variations among the chips are variations of operating/ring oscillator oscillating frequencies among a plurality of LSI chips, caused by differences in locations where the LSI chips are produced on the wafer, and other factors.

Step 3: It is considered that the prediction of frequency distribution of the timing yield rate of the chip with variations in the chip being taken into consideration appears as a change in the variations among the chips, like the difference between the spec value of the ring oscillator and the actual distribution of ring oscillator oscillating frequencies.

Step 4: In order to add the influence of the change in the variations among the chips to the prediction of frequency distribution of the timing yield rate of the chip with variations in the chip being taken into consideration, the statistical addition is carried out among the distributions, resulting in the prediction of frequency distribution with variations in and among the chips being taken into consideration. It is possible to predict the timing yield rate of each rank from the distribution prediction. Here, the rank is a frequency range when the LSI chips are purchased, and are classified by frequency range based on the result of examining which frequencies actually allow the LSI chips to operate.

According to the above prediction, the frequency yield of each lot is predicted with a value of the variations in the chips (called αk: the spread (standard deviation) of frequency distribution when the frequency characteristics of FF and other components in the chip, which are input as initial data when the frequency distribution of the timing yield rate is calculated by conducting the statistical timing analysis, are seen as Gaussian distribution) being fixed at a predetermined value. k is a positive integer.

Furthermore, according to the prerequisite technology, as described above, with the in-chip variation αk variable, fitting is carried out with data obtained from the timing yield rate of the LSI chip used in the past in order to calculate the in-chip variation αk corresponding to the oldest timing yield rate data acquired in the past. With the use of the in-chip variation αk, the timing yield rate of the LSI chip to be newly purchased is predicted. Therefore, it is possible to accurately predict.

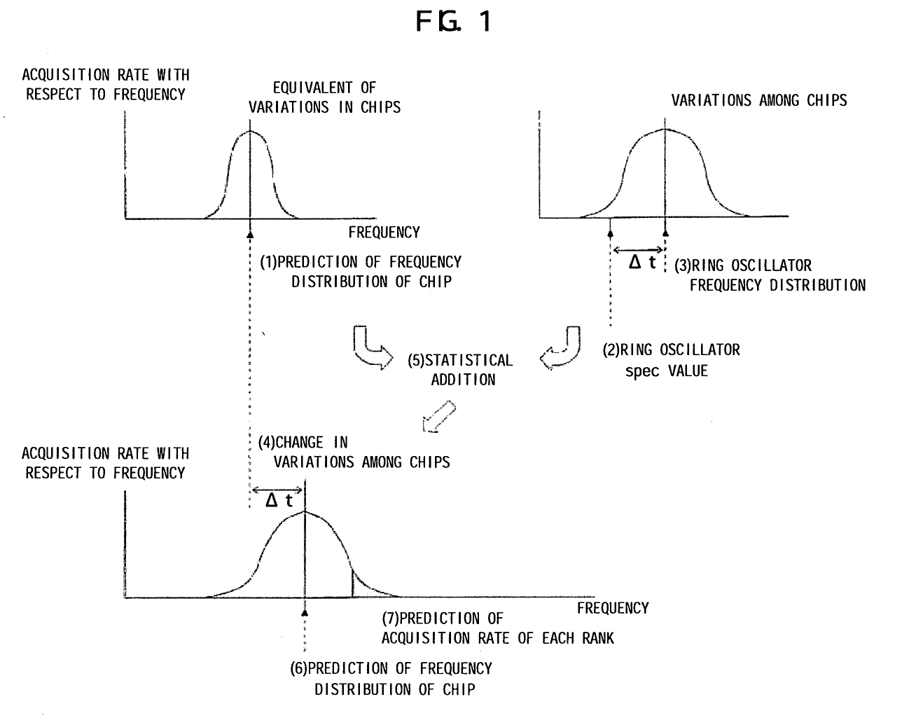

FIG. 1 is a diagram illustrating a yield prediction process according to the prerequisite technology. A graph depicted on the upper left side of FIG. 1 represents the distribution of chip timing yield rates, obtained as a result of conducting the statistical timing analysis with no variation among the chips being taken into account and with an appropriate value (10%, for example) of the in-chip variation. In the diagram, the horizontal axis represents frequency, while the vertical axis represents the occurrence rate of the timing yield rate of the chip and each frequency with respect to frequency. As illustrated in (1) of FIG. 1, the frequency distribution in the chip is obtained.

A diagram depicted on the upper right side of FIG. 1 represents the distribution of ring oscillator oscillating frequencies among a plurality of chips, obtained as a result of measuring the ring oscillator oscillating frequencies of all chips in the same lot. (3) of FIG. 1 is an average calculated from the distribution obtained as a result of measuring the ring oscillator oscillating frequencies of all chips in the same lot. An arrow indicated by (2) is the spec value of the ring oscillator oscillating frequency. Accordingly, the difference (Δt) between the spec value of (2) and the actual oscillating frequency (3) of the chip is calculated.

In the statistical addition (5) in FIG. 1, the convolution is conducted on the frequency distribution in the chip and on the frequency distribution/variations among the chips. As a result, with the variations in the chip and among the chips being taken into account, the frequency distribution of the chip of (6) is obtained as illustrated in the lower side of FIG. 1. Here, Δt calculated in advance is also taken into account. The change Δt in the variations among the chips of (4) appears as a deviation from the in-chip variation (1) of the frequency distribution (6) obtained as a result of the statistical addition. The deviation (6) is divided into frequency segments, and an integral is performed in each segment. Therefore, the prediction (7) of timing yield rate of the LSI chip is obtained on a per-frequency-rank basis.

The following describes the distribution. As a distribution function, there are a probability density function (PDF: corresponding to the frequency distribution of timing yield rates in the above case), a cumulative distribution function (CDF) obtained as a result of integration thereof. Moreover, the PDF can be obtained by differentiating the CDF. The statistical addition is performed by the convolution. The convolution is not described here because the calculation method and characteristic of the convolution are well known.

The following describes how to calculate the in-chip variation αk.

The frequency distribution of all the chips obtained from the past lot has been basically measured as a frequency yield distribution (cumulative distribution function). That is, regarding the past lot, the distribution of (6) in FIG. 1 can be known in advance. Moreover, assume that the distribution of ring oscillator oscillating frequencies of (3) in FIG. 1 is already known after the individual chips are measured. Here, the values of in-chip variation are assumed to be different from each other in the range of around 0% to 30%, like 0%, 0.5%, 1%, 1.5% . . . , and the statistical timing analysis is conducted to calculate the distribution of each value. Fitting is carried out for the distribution and the already known frequency yield distribution, and a point where the distribution becomes equal to the already known frequency yield distribution is regarded as the in-chip variation αk.

When there is no past statistical data because the new LSI products have been introduced, the average of in-chip variations of the older LSI products is used.

According to the prerequisite technology, the prediction of the frequency yield distribution includes the calculation of αk, the accumulation of the past αk, and the prediction of αk of the next lot.

The LSI chips are produced on a per-lot basis. The ring oscillator oscillating frequencies of all the produced chips are measured, and the operation distribution with respect frequency is obtained and is regarded as an in-chip variation β. With the in-chip variation β being fixed, the in-chip variation αk is calculated. However, each lot has a different αk, and it is impossible to calculate the in-chip variation αk. Therefore, αk is divided at certain intervals for example in the range of 1% to 25% to calculate the in-chip variations, and fitting is performed between each of the calculated in-chip variations and the past αk to calculate the in-chip variation αk. The calculated αk obtained by fitting is accumulated on a per-lot basis. Then, the in-chip variation of the newly produced lot is predicted from the accumulated αk of the past lot.

The following describes how to calculate the above-mentioned in-chip variation αk.

The following are data input into a system which carries out the process of the prerequisite technology.

1. αinit: an initial value of the in-chip variation
2. αlast: a final value of the in-chip variation
3. Δα: an in-chip variation increment value when the process is repeated
4. β: the in-chip variation (measured from the ring oscillator)

The initial and final values of the in-chip variation represent the initial and final values of the in-chip variation when the in-chip frequency distribution is calculated with the in-chip variation varying. Δα is the amount of change for each change of the in-chip variation.

What is to be output is the following.

5. The timing yield rate of each frequency rank of the lot

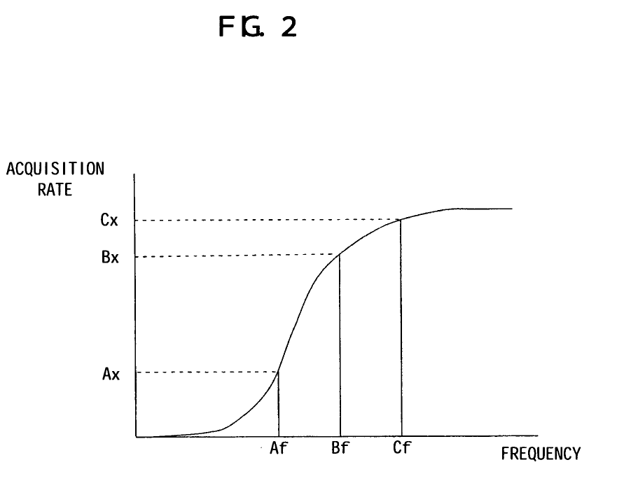

FIG. 2 is a graph illustrating an example of the timing yield rate distribution obtained by the prerequisite technology. In the graph, the horizontal axis represents frequency, while the vertical axis represents the timing yield rate. Here, the timing yield rate of a rank operating at 2.0 [GHz] (Af) is Ax. Moreover, the timing yield rate of a rank operating at 1.8 [GHz] (Bf) is Bx. Furthermore, the timing yield rate of a rank operating at 1.6 [GHz] (Cf) is Cx.

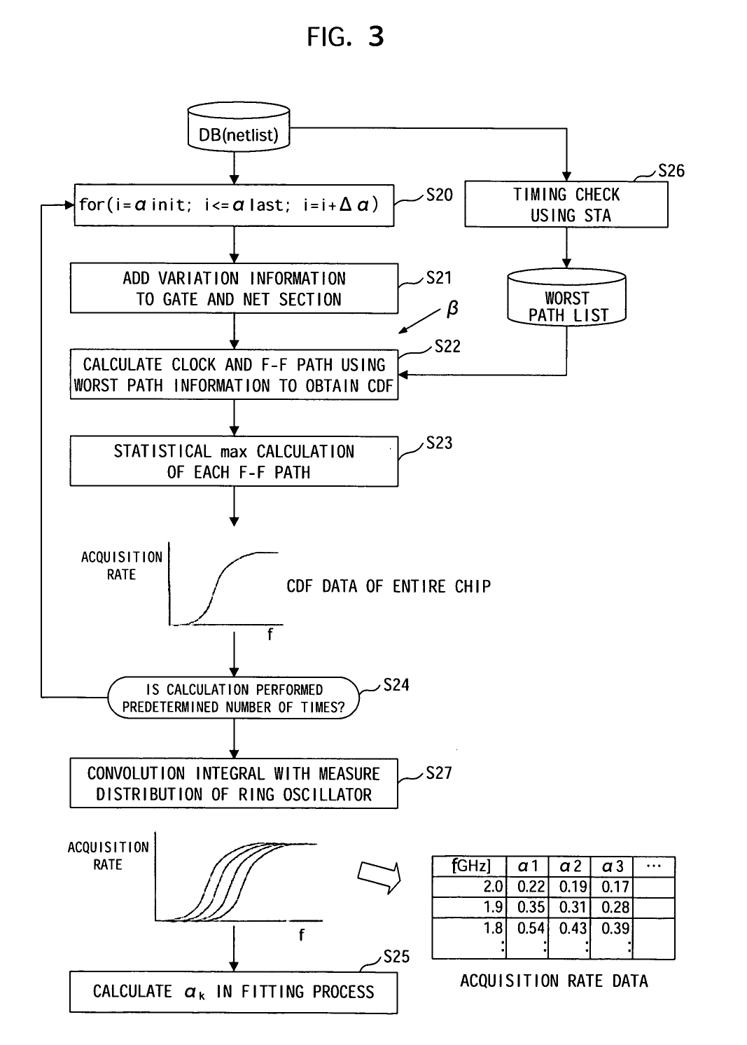

FIG. 3 is a flowchart illustrating an example of an in-chip variation calculation method according to the prerequisite technology.

At step S26, a net list is read out from a database, and a timing check is carried out with the use of STA (Setup Time Analysis) to generate a worst path list. The worst path list is the result of the normal STA (Setup Time Analysis). In the worst path list, the pieces of path information of a source FF and a sink FF are arranged from worst to better.

On the other hand, in a loop from step S20 to step S24, the in-chip variation is changed, and calculation of the in-chip frequency distribution is repeated. On the condition of step S20, a determination is made as to whether the process is performed a predetermined number of times at step S24. At step S21, the initial information including the frequency characteristics with the variation information being added to a gate and a net section is generated. At step S22, a clock and a F-F path are calculated from the worst path information obtained from the worst path list, and the CDF, i.e. the in-chip frequency distribution, is calculated. At step S23, the statistical max operation (statistical operation) of each F-F path is performed, and the CDF data of the entire chip is obtained. The process is performed for each of the varying in-chip variations. As a result, the CDF data is obtained for each of a plurality of the in-chip variations α1, α2, α3, . . . . The convolution is performed on the obtained CDF data and the CDF data obtained by measurement of the ring oscillator.

Here, the convolution is conducted on the PDF which is the in-chip frequency distribution and on the PDF which is the measured frequency distribution of the ring oscillator. After that, the CDF of the timing yield rate may be calculated by integration. Alternatively, the integration of the PDF which is the in-chip frequency distribution and the PDF which is the measured frequency distribution of the ring oscillator may be first performed to calculate the CDF of the chip and the CDF of the measured value of the ring oscillator, and the CDF of the timing yield rate may be calculated by the convolution.

From the CDF of the timing yield rate obtained after step S27, the timing yield rate of each rank, like the acquisition data illustrated in FIG. 3, is obtained in line with the values of the variations in each chip. Then, at step S25, the value of the most appropriate in-chip variation αk is calculated by the fitting process.

Then, with the use of the statistical timing analysis result corresponding to the determined αk and the measurement result of the ring oscillator mounted on the LSI chip of the past lot, the cumulative probability distribution of the timing yield rate is obtained. Based on the cumulative probability distribution, the timing yield rate of the next lot is predicted.

The following describes the entire sequence of the prerequisite technology.

Firstly, the design data of the chip, such as the net list, is input, and the statistical timing analysis is carried out for each LSI chip. Then, the in-chip variation is changed, and a determination is made as to whether calculation has been conducted for every in-chip variation. When calculation has not yet been performed for every in-chip variation, the statistical timing analysis is performed with the assumed new in-chip variation.

When calculation has been performed for every in-chip variation, the convolution is performed on the frequency distribution of the timing yield rate corresponding to each in-chip variation obtained by the statistical timing analysis and the frequency distribution obtained by measurement of the ring oscillator. The frequency distribution of the ring oscillator to be used is obtained after the frequency of the ring oscillator actually mounted on the LSI chip is measured on every chip of one lot. Then, each distribution obtained as a result of the convolution is integrated, and the cumulative probability distribution (CDF) corresponding to each in-chip variation is obtained. Subsequently, fitting is carried out on the obtained cumulative probability distribution and the cumulative probability distribution obtained by integrating the frequency distribution of chips of the past lot, and the appropriate in-chip variation αk is calculated. Then, the cumulative probability distribution corresponding to the calculated αk is calculated, and the timing yield rate prediction value of each rank is obtained.

The process described above can be automatically performed by a computer.

The following describes an example of an embodiment of the present invention with reference to the accompanying diagrams.

Like the prerequisite technology described above, when the frequency distribution of each path is created based on the path information of the worst path list, and when the frequency distribution of the chip is produced from the frequency distribution of each path, it takes longer and longer time to process as the number of paths increases. According to the present invention, provided is a timing analysis apparatus that selects an appropriate path to be used to calculate the frequency distribution of the chip.

The following describes the configuration of the timing analysis apparatus according to the present embodiment.

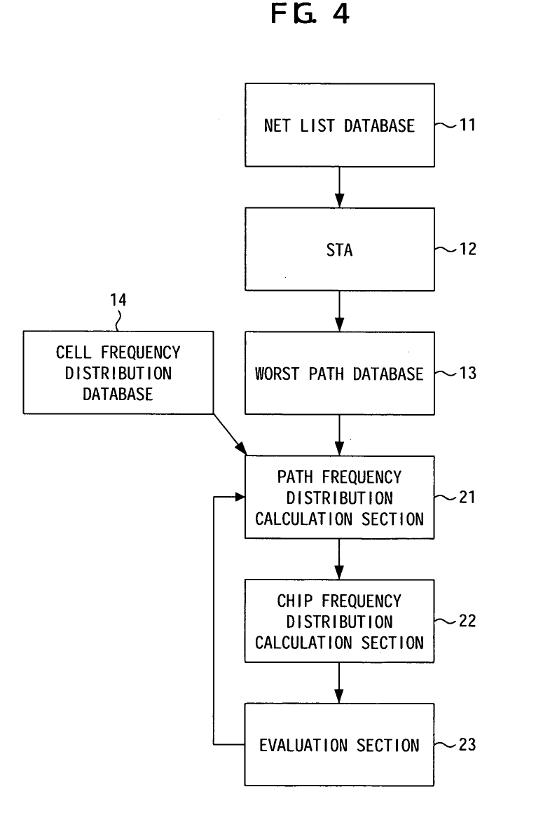

FIG. 4 is a block diagram illustrating an example of the configuration of the timing analysis apparatus according to the present embodiment. The timing analysis apparatus includes a net list database 11, a STA 12, a worst path database 13, a cell frequency distribution database 14, a path frequency distribution calculation section 21, a chip frequency distribution calculation section 22, and an evaluation section 23.

The net list database 11 is a storage section storing a net list, which is the design information of the chip (integrated circuit) on which the timing analysis to be conducted. The worst path database 13 is a storage section in which the pieces of path information, each of which is information about a F-F path (critical path) on the targeted chip, are stored from worst to better in terms of path's operating frequency (delay, and propagation time). The cell frequency distribution database 14 is a storage section storing the cell frequency distribution which is the PDF of the operating frequency of each cell of the targeted chip. Incidentally, delay may be used instead of frequency; the delay distribution may be used instead of the frequency distribution.

The following describes the operation of the timing analysis apparatus according to the present embodiment.

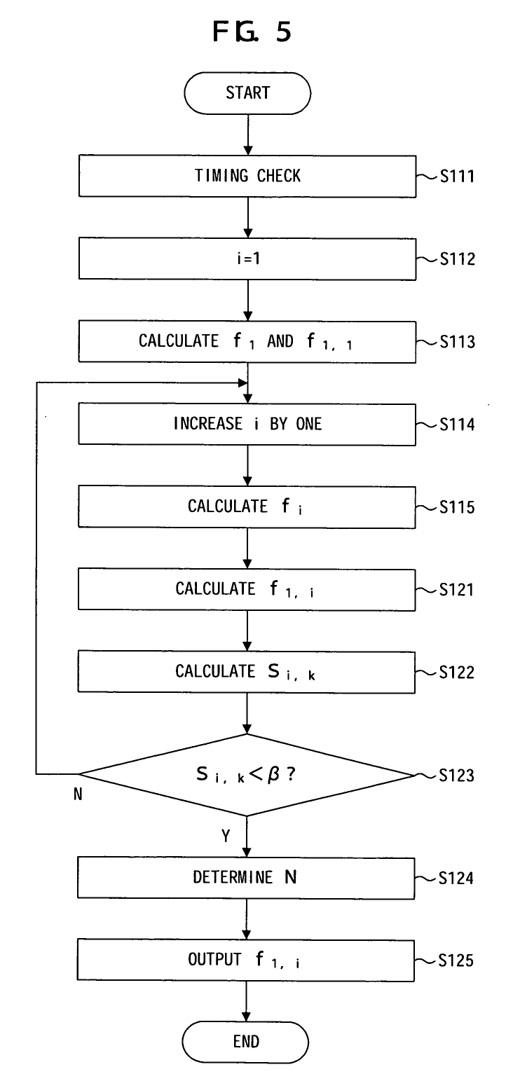

FIG. 5 is a flowchart illustrating an example of the operation of the timing analysis apparatus according to the present embodiment. Firstly, the STA 12 reads out the net lest of the chip stored in the net list database 11 to carry out a timing check, and saves the timing check result in the worst path database 13 (S111).

Then, the path frequency distribution calculation section 21 sets a worst path ranking i to 1 (S112), reads out from the worst path database 13 the path information about the worst path 1 which is a path whose worst path ranking is 1st, reads out from the cell frequency distribution database 14 the cell frequency distribution of a cell used for the worst path 1, calculates from the path information and the cell frequency distribution the path frequency distribution (path capability distribution) f₁ which is the PDF of the operating frequency of the worst path 1, and regards the path frequency distribution f₁ as the chip frequency distribution f_{1, 1} (S113). i is a positive integer.

Then, the path frequency distribution calculation section 21 increases i by one (S114), and calculates the path frequency distribution fᵢ in a similar way to the process S113 (S115). Then, the chip frequency distribution calculation section 22 performs the statistical max operation on the path frequency distribution fᵢ and the chip frequency distribution (integrated circuit capability distribution) f_{1, i-1} that is the PDF of the operating frequency of the chip which uses the worst paths 1 to (i−1), and regards the resultant PDF as the chip frequency distribution f_{1, i} (S121).

Subsequently, the evaluation section 23 calculates a sensitivity S_{i, k} from the chip frequency distribution f_{1, i-1} (first integrated circuit capability distribution) and the chip frequency distribution f_{1, i} (second integrated circuit capability distribution) (S122). Then, the evaluation section 23 makes a determination as to whether the obtained S_{i, k} satisfies S_{i, k}<β (S123). Here, β is a threshold for the sensitivity that is set in advance according to calculation accuracy, and is for example ( 1/100000).

If the obtained S_{i, k} does not satisfy S_{i, k}<β (S123, N), the process S114 is retried. If the obtained S_{i, k} satisfies S_{i, k}<β (S123, Y), the evaluation section 23 outputs the worst path number N that is equal to i (S124), outputs and writes which is the PDF of the chip frequency distribution, or F_{1, i}, which is the CDF, in the storage section (S125), and ends the flow.

The following describes the sensitivity.

Firstly, the evaluation section 23 calculates y=F_{1, i-1}(x) and y=F_{1, i}(x) that are CDF and correspond to f_{1, i-1} and f_{1, i}, which are PDF. Here, x represents the operating frequency, and y represents the timing yield rate of chips satisfying the operating frequency x. Furthermore, the evaluation section 23 calculates the inverse functions of CDF, x=F_{1, i-1}⁻¹(y) and x=F_{1, i}⁻¹(y).

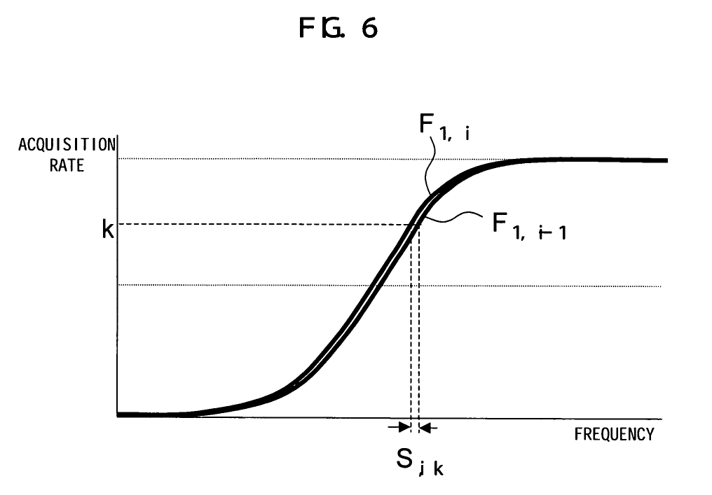

FIG. 6 is a graph illustrating an example of the definition of sensitivity according to the present embodiment. In the graph, the horizontal axis represents frequency, and the vertical axis represents the timing yield rate. The curved lines represent F_{1, i-1}, which is the CDF of the chip frequency distribution that uses the worst paths 1 to (i−1), and F_{1, i}, which is the CDF of the chip frequency distribution that uses the worst paths 1 to i.

If the desired timing yield rate (frequency yield) of the targeted chip is k (80%, for example), the evaluation section 23 calculates the frequencies F_{1, i-1}⁻¹(k) and F_{1, i}⁻¹(k) so that the timing yield rate is k thanks to the inverse functions of CDF, and defines the sensitivity S_{i, k} in the following equation.

S_{i,k}=F_{1,i-1}⁻¹(k)−F_{1,i}⁻¹(k)

According to the above-described operation of the timing analysis apparatus, the sensitivity becomes smaller as the worst path number i increases, and the sensitivity finally drops below the threshold β. Paths are added from worst to better to calculate the chip frequency distribution; the process is repeated until the sensitivity S_{i, k} drops below the threshold β. Therefore, an appropriate number of the worst paths can be selected in order to calculate the chip frequency distribution. Moreover, the path frequency distribution is calculated in order of worst to better, and the statistical max operation is performed on the calculated path frequency distribution and the chip frequency distribution. Therefore, the amount of calculation can be optimized to stop calculation at a time when the number of the worst paths becomes enough.

Therefore, with the level of accuracy being maintained, the chip frequency distribution and the timing yield rate of chips satisfying the desired capability can be calculated at high speed. Moreover, since the timing yield rate can be efficiently predicted, the electronic devices that use the high-speed LSI chips can be produced at low cost.

Incidentally, an acquisition section includes the STA and the worst path database in the embodiment of the present invention. A path capability distribution calculation section includes the path frequency distribution calculation section in the embodiment of the present invention. An integrated circuit capability distribution calculation section includes a chip frequency distribution calculation section in the embodiment of the present invention.

Moreover, an acquisition step includes the processes S111, S112, and S114 in the embodiment of the present invention. A path capability distribution calculation step includes the processes S113 and S115 in the embodiment of the present invention. An integrated circuit capability distribution calculation step includes the process S121 in the embodiment of the present invention. An evaluation step includes the processes S122 and S123 in the embodiment of the present invention.

Furthermore, a program that makes a computer constituting the timing analysis apparatus to execute each of the above-described steps can be provided as a timing analysis program. The above-mentioned program can be stored in a computer-readable storage medium, and can therefore be executed by the CPU of the computer constituting the timing analysis apparatus. The computer-readable storage medium includes an internal storage device, which is mounted inside the computer, such as ROM and RAM; a portable storage medium, such as CD-ROM, a flexible disk, a DVD disk, a magneto optical disk, and an IC card; a database in which a computer program is saved; another computer; and a database thereof.

According to the present embodiment, the capability distribution of the integrated circuit can be efficiently predicted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A timing analysis apparatus that performs a timing analysis of an integrated circuit, comprising:
an acquisition section that acquires information on a plurality of paths which let signals propagate in the integrated circuit in descending order of propagation time;
a path capability distribution calculation section that calculates, based on the acquired information on the plurality of paths, path capability distribution which is a probability density function of capability of the plurality of paths;
an integrated circuit capability distribution calculation section that performs a statistical operation based on the path capability distribution and on first integrated circuit capability distribution which is a probability density function of capability of the chip, and determines the result of the statistical operation as second integrated circuit capability distribution which is a probability density function of capability of the chip, the first integrated circuit capability distribution being the path capability distribution calculated first or the second integrated circuit capability distribution determined last; and
an evaluation section that calculates a parameter representing a difference between the first integrated circuit capability distribution and the second integrated circuit capability distribution, and repeats the process of the acquisition section, the process of the path capability distribution calculation section, and the process of the integrated circuit capability distribution calculation section until the parameter satisfies a predetermined condition.

2. The timing analysis apparatus according to claim 1, wherein
the evaluation section calculates a first cumulative distribution function which is a cumulative distribution function of the first integrated circuit capability distribution and a second cumulative distribution function which is a cumulative distribution function of the second integrated circuit capability distribution, calculates a first capability value that is a value of capability which lets the first cumulative distribution function become a predetermined probability and a second capability value that is a value of capability which lets the second cumulative distribution function become the predetermined probability, and calculates the difference between the first capability value and the second capability value as the parameter.

3. The timing analysis apparatus according to claim 2, wherein
the evaluation section calculates the inverse function of the first cumulative distribution function and the inverse function of the second cumulative distribution function, calculates, based on the inverse function of the first cumulative distribution function, the first capability value, and calculates, based on the inverse function of the second cumulative distribution function, the second capability value.

4. The timing analysis apparatus according to claim 1, wherein
the capability is propagation time or operating frequency.

5. The timing analysis apparatus according to claim 1, wherein
the predetermined condition is that the parameter drops below a predetermined value.

6. The timing analysis apparatus according to claim 1, wherein
the acquisition section uses design information of the integrated circuit to perform a timing check, and arranges the information on the plurality of paths in descending order of propagation time.

7. The timing analysis apparatus according to claim 1, wherein
the path capability distribution calculation section acquires, from the information on the plurality of paths acquired by the acquisition section, distribution of capability of cells included in the plurality of paths, and calculates the path capability distribution based on the distribution of capability of the cells.

8. The timing analysis apparatus according to claim 1, wherein
the predetermined probability is an timing yield rate of the integrated circuit.

9. The timing analysis apparatus according to claim 1, wherein
the evaluation section outputs the second integrated circuit capability distribution when the parameter satisfies the predetermined condition.

10. The timing analysis apparatus according to claim 1, wherein
the evaluation section outputs the number of the paths acquired by the acquisition section when the parameter satisfies the predetermined condition.

11. A computer-readable storage medium storing a timing analysis program that causes a computer to execute a process to perform a timing analysis of an integrated circuit, the process comprising:
acquiring information on a plurality of paths which let signals propagate in the integrated circuit in descending order of propagation time;
calculating, based on the acquired information on the plurality of paths, path capability distribution which is a probability density function of capability of the plurality of paths;
performing a statistical operation based on the path capability distribution and on first integrated circuit capability distribution which is a probability density function of capability of the chip, and determining the result of the statistical operation as second integrated circuit capability distribution which is a probability density function of capability of the chip, the first integrated circuit capability distribution being the path capability distribution calculated first or the second integrated circuit capability distribution determined last;
calculating a parameter representing a difference between the first integrated circuit capability distribution and the second integrated circuit capability distribution; and
repeating the acquiring, the calculating of the path capability distribution, the determining of the integrated circuit capability distribution, and the calculating of the parameter until the parameter satisfies a predetermined condition.

12. The computer-readable storage medium according to claim 11, wherein
the calculating of the parameter calculates a first cumulative distribution function which is a cumulative distribution function of the first integrated circuit capability distribution and a second cumulative distribution function which is a cumulative distribution function of the second integrated circuit capability distribution, calculates a first capability value that is a value of capability which lets the first cumulative distribution function become a predetermined probability and a second capability value that is a value of capability which lets the second cumulative distribution function become the predetermined probability, and calculates the difference between the first capability value and the second capability value as the parameter.

13. The computer-readable storage medium according to claim 12, wherein
the calculating of the parameter calculates the inverse function of the first cumulative distribution function and the inverse function of the second cumulative distribution function, calculates, based on the inverse function of the first cumulative distribution function, the first capability value, and calculates, based on the inverse function of the second cumulative distribution function, the second capability value.

14. The computer-readable storage medium according to claim 11, wherein
the capability is propagation time or operating frequency.

15. The computer-readable storage medium according to claim 11, wherein
the predetermined condition is that the parameter drops below a predetermined value.

16. The computer-readable storage medium according to claim 11, wherein
the acquiring uses design information of the integrated circuit to perform a timing check, and arranges the information on the plurality of paths in descending order of propagation time.

17. The computer-readable storage medium according to claim 11, wherein
the calculating of the path capability distribution acquires, from the acquired information on the plurality of paths, distribution of capability of cells included in the plurality of paths, and calculates the path capability distribution based on the distribution of capability of the cells.

18. A timing analysis method using a computer to perform a timing analysis of an integrated circuit, comprising:
acquiring information on a plurality of paths which let signals propagate in the integrated circuit in descending order of propagation time;
calculating, based on the acquired information on the plurality of paths, path capability distribution which is a probability density function of capability of the plurality of paths;
performing a statistical operation based on the path capability distribution and on first integrated circuit capability distribution which is a probability density function of capability of the chip, and determining the result of the statistical operation as second integrated circuit capability distribution which is a probability density function of capability of the chip, the first integrated circuit capability distribution being the path capability distribution calculated first or the second integrated circuit capability distribution determined last;
calculating a parameter representing a difference between the first integrated circuit capability distribution and the second integrated circuit capability distribution; and
repeating the acquiring, the calculating of the path capability distribution, the determining of the integrated circuit capability distribution, and the calculating of the parameter until the parameter satisfies a predetermined condition.

19. The timing analysis method according to claim 18, wherein
the calculating of the parameter calculates a first cumulative distribution function which is a cumulative distribution function of the first integrated circuit capability distribution and a second cumulative distribution function which is a cumulative distribution function of the second integrated circuit capability distribution, calculates a first capability value that is a value of capability which lets the first cumulative distribution function become a predetermined probability and a second capability value that is a value of capability which lets the second cumulative distribution function become the predetermined probability, and calculates the difference between the first capability value and the second capability value as the parameter.

20. The timing analysis method according to claim 19, wherein
the calculating of the parameter calculates the inverse function of the first cumulative distribution function and the inverse function of the second cumulative distribution function, calculates, based on the inverse function of the first cumulative distribution function, the first capability value, and calculates, based on the inverse function of the second cumulative distribution function, the second capability value.
